(19) United States
(12) Patent Application Publication
(10) Pub. No.: US 2026/0086047 A1
(43) Pub. Date: Mar. 26, 2026

(54) METHODS FOR CALIBRATING AND APPLYING A FLEXIBLE X-RAY IMAGING SYSTEM

(71) Applicant: Siemens Healthineers AG, Forchheim (DE)

(72) Inventor: Ludwig RITSCHL, Buttenheim (DE)

(73) Assignee: Siemens Healthineers AG, Forchheim (DE)

(21) Appl. No.: 19/336,801

(22) Filed: Sep. 23, 2025

(30) Foreign Application Priority Data
Sep. 24, 2024 (DE) 10 2024 209 150.2

(51) Int. Cl. G01N 23/04

(52) U.S. Cl. CPC G01N 23/04; G01N 2223/303; G01N 2223/3303; G01N 2223/419

(57) ABSTRACT

A method for calibrated X-ray imaging, with an X-ray imaging system with a radiation emitter with variable pose and an X-ray detector with a variable pose which can be actuated independently of the variable pose of the radiation emitter is described. A calibration and control device and an X-ray imaging system are also described.

### CROSS-REFERENCE TO RELATED APPLICATION(S)

The present application claims priority under 35 U.S.C. § 119 to German Patent Application No. 10 2024 209 150.2, filed Sep. 24, 2024, the entire contents of which are incorporated herein by reference.

### FIELD

One or more example embodiments relates to a method for calibrated X-ray imaging, with an X-ray imaging system with a radiation emitter with variable pose and an X-ray detector with a variable pose which can be actuated independently of the variable pose of the radiation emitter. One or more example embodiments also relates to a calibration and control facility. One or more example embodiments relates, moreover, to an X-ray imaging system.

### RELATED ART

In addition to 2D recordings, it is also possible to produce 3D recordings (Cone Beam CT, CBCT) using flexible robotic X-ray imaging systems, such as robot-assisted ceiling-guided X-ray imaging systems. It is primarily when the X-ray tube, also referred to as a radiation emitter, and the X-ray detector are not mechanically coupled that a very precise mechanical calibration and adjustment of the system has to be carried out so the position and the orientation of the X-ray tube and the X-ray detector are optimum to one another in all spatial positions.

A CBCT system is typically calibrated with X-ray recordings using a calibration phantom, also referred to as an X-ray phantom, from which X-ray images are recorded. The projection geometry can be back-calculated on the basis of such “X-ray phantom images”. However, the following conditions must be met for such a calibration: the trajectory of the CBCT system can be reproduced except for statistical deviations around a mean. The statistical deviations can be eliminated by way of a jitter correction, for example. The tube and the X-ray detector move on paths which can, on average, be reproduced relative to one another. This can be achieved by way of a complete mechanical link, for example via a C-arm or a gantry, or a partial link, for example via ceiling mounts on shared suspension devices, with simultaneously synchronized movement control.

### SUMMARY

However, it would also be attractive to use X-ray systems, in particular CBCT systems, which are based on mechanically independent units for the X-ray tube and the X-ray detector. One example of this would be a rotatable motorized X-ray detector bracket on a mobile stand, which, in combination with an X-ray ceiling mount, could be used for CBCT recordings.

At least some example embodiments disclose a method and an apparatus for calibration and application of an X-ray imaging system with mechanically independent units for the X-ray tubes and the X-ray detector.

This is achieved by a method for calibration and application of an X-ray imaging system, with a radiation emitter with variable pose and an X-ray detector with a variable pose, which can be actuated independently of the variable pose of the radiation emitter, a calibration and control facility and an X-ray imaging system.

### BRIEF DESCRIPTION OF THE DRAWINGS

The invention will be explained in more detail once again below on the basis of exemplary embodiments and with reference to the accompanying figures. In the drawings:

FIG. 1 shows a schematic representation of an X-ray imaging system according to one exemplary embodiment of the invention,

FIG. 2 shows a flowchart which illustrates a method for calibrated X-ray imaging, with an X-ray imaging system with a radiation emitter with variable pose and an X-ray detector with a variable pose which can be actuated independently of the variable pose of the radiation emitter, according to a first exemplary embodiment of the invention,

FIG. 3 shows a flowchart which illustrates a method for calibrated X-ray imaging with an X-ray imaging system with a radiation emitter with variable pose and an X-ray detector with a variable pose which can be actuated independently of the variable pose of the radiation emitter, according to a second exemplary embodiment of the invention,

FIG. 4 shows a flowchart, which illustrates a method for calibrated X-ray imaging with an X-ray imaging system with a radiation emitter with variable pose and an X-ray detector with a variable pose which can be actuated independently of the variable pose of the radiation emitter, according to a third exemplary embodiment of the invention, and

FIG. 5 shows a schematic representation of a calibration and control facility according to an exemplary embodiment of the invention.

### DETAILED DESCRIPTION

In an inventive method for calibrated X-ray imaging, with an X-ray imaging system with a radiation emitter with variable pose and an X-ray detector with a variable pose which can be actuated independently of the variable pose of the radiation emitter, firstly an initial calibration is carried out by way of X-ray mapping of an X-ray phantom on the X-ray detector for a plurality of different poses of the radiation emitter and the X-ray detector, wherein a plurality of initial projections C(n, R0, t0) is ascertained. A radiation emitter should be taken to mean an apparatus for emitting X-ray radiation, also referred to as an X-ray tube.

As will be explained later, initial optical image data can optionally be captured by the radiation emitter and/or the X-ray detector. Initial optical image data should be taken to mean image data which is generated not with X-rays but with an additional image recording unit which can be used in parallel with an X-ray recording or a system comprising radiation emitter and X-ray detector. In this preferred variant, initial poses of the X-ray detector relative to the radiation emitter are ascertained on the basis of the initial optical image data. Since the optical image data comprises items of information about the position and orientation of the radiation emitter and/or the X-ray detector, it can be used for ascertaining a relative pose between said components. In this context “optical” should be taken to mean that no X-rays are used for image generation. Particularly preferably, the electromagnetic waves used for generating the optical image data are in the visible range. However, imaging methods which function with electromagnetic waves in the UV range or the IR range should also be included. An X-ray phantom is an object which has certain mapping properties which are used for an examination and adaption of imaging behavior of an X-ray imaging system. In particular, the X-ray phantom can have patterns which are projected on the X-ray detector by the X-rays and provide information on the pose of the radiation emitter relative to the X-ray detector.

Therefore, firstly an initial calibration is carried out by ascertaining absolute calibrated poses of the radiation emitter and the X-ray detector by way of X-ray mapping of an X-ray phantom on the X-ray detector for a plurality of different poses of the radiation emitter and the X-ray detector. An “absolute pose” should in this case be taken to mean a pose in a stationary coordinate system of the X-ray imaging system. The X-ray phantom is preferably positioned exactly in the origin of the stationary coordinate system. The initial calibration preferably takes place in the world coordinate system of the X-ray phantom used for the calibration. In contrast to the ascertainment of relative poses, in this step absolute poses of the radiation emitter and the X-ray detector are therefore ascertained and compared with values which are used for actuating these components. As a rule, the trajectories actually described by the radiation emitter and the X-ray detector during the calibration and actuated absolute poses are not ideal. After calibration, however, the exact poses or deviations of the calibrated trajectories from the ideal trajectories are known. After the calibration the exact course of the trajectories is therefore known and the exact poses of the components, when predetermined poses or a predetermined trajectory are actuated, are known. However, the relative poses can deviate from the original relative poses due to misalignments. However, a recalibration with the aid of an X-ray phantom would be time-consuming and would also always harbor the uncertainty that a misalignment can occur in the period between the calibration and the actual X-ray image recording of an examination object or examination region. In particular, a deviation of the relative pose of the radiation emitter and the X-ray detector can occur.

In other words, initially a plurality of initial projections, in particular projection matrices C(n,R0, t0), is calibrated per X-ray phantom. In this case, n is an index which unequivocally describes a position on the X-ray detector trajectory and the radiation emitter trajectory. Radiation emitter and X-ray detector are also coordinated with each other timewise. R0 is the initial rotation, t0 is the initial shift during the calibration. R0 and t0 are preferably determined by the image recording unit.

Furthermore, the X-ray imaging system for capturing X-ray projection data from an examination object is applied, wherein during capture of the X-ray projection data for a plurality of different poses of the radiation emitter and the X-ray detector, optical image data, which reproduces poses of the X-ray detector relative to the radiation emitter, is ascertained.

The X-ray imaging system is applied for capturing X-ray projection data from an examination object, wherein during capture of the X-ray projection data for a plurality of the absolute calibrated poses of the radiation emitter and the X-ray detector, new poses of the X-ray detector relative to the radiation emitter are ascertained by recapturing new optical image data respectively. Therefore, at the same time as the actual X-ray recording, optical image data is also captured, on the basis of which a deviation of the poses of the X-ray detector relative to the radiation emitter can be noted.

Corrected projections C(n, R1, t1) are ascertained, moreover, on the basis of the poses of the X-ray detector relative to the radiation, ascertained on the basis of the (new) optical image data emitter and on the basis of the initial calibration.

Finally, X-ray image data is reconstructed on the basis of the captured X-ray projection data and on the basis of the corrected projections C(n, R1, t1).

A transformation, which indicates a deviation of the poses of the radiation emitter and the X-ray detector during capture of the X-ray projection data from the absolute calibrated poses of the initial calibration, is ascertained on the basis of the initial relative poses and the new relative poses. The transformation is preferably ascertained by way of a regression, particularly preferably by a least squares method, which is preferably applied to the initial relative poses, ascertained using the initial optical image data and the new optical image data, and newly ascertained relative poses.

In other words, during the actual X-ray imaging of an examination object by way of an optical image recording, a divergent rotation R1 different from the initial rotation R0 already ascertained during the calibration and a divergent translation t1 different from the initial translation t0 are ascertained. That is to say that the coefficients of the initial calibrated projection matrices C(n,R0, t0) cannot be used. Therefore, a new rotation R1 and a new translation t1 have to be ascertained at the same time as the X-ray imaging by way of a new recording of optical image data. On the basis of the initial projection matrices C(n,R0, t0), the initial rotation R0 and translation t0, the new rotation R1 and the new translation t, it is now possible to determine a transformation F with which the new projection matrices C(n, R_1,t_1)=TR(C(n, R0,t0), R0, t0, R1, t1) can be ascertained which can be used for a subsequent image reconstruction. The transformation F is based on a separation of the projection matrix C(n,R0, t0) into vectors S, 0, U, V, to which the difference between R0 and R1 as well as t0 and t1, which is possibly ascertained by a regression, can be applied. The vector S indicates the position of the radiation emitter, the vector O indicates the position of the X-ray detector, the vectors U, V span the X-ray detector surface of the X-ray detector. The corrected vectors S, O, U, V can then be recombined to form the new projection matrices C(n, R1,t1) and be used for an image reconstruction for correction of captured X-ray projection data.

The described type of correction is also explained in: “Kyriakou Y, Lapp R M, Hillebrand L, Ertel D, Kalender W A. Simultaneous misalignment correction for approximate circular cone-beam computed tomography. Phys Med Biol. 2008 Nov. 21; 53(22):6267-89. doi: 10.1088/0031-9155/53/22/001. Epub 2008 Oct. 20. PMID: 18936522.”

X-ray image data is reconstructed on the basis of the captured X-ray projection data, the absolute calibrated poses of the radiation emitter and the X-ray detector or the resulting initial projection matrices C(n,R0, t0) and the transformation TR. Advantageously, a variable portion of the poses of the radiation emitter and the X-ray detector can be “calibrated in addition” virtually simultaneously during the image recording on the basis of optical image data without a separate, second complete calibration having to be executed. It is sufficient in this connection to capture the relative changes between the pose of the radiation emitter and the X-ray detector, while the absolute poses only have to be initially calibrated once.

The inventive calibration and control facility has a calibration unit for carrying out an initial calibration by way of X-ray mapping of an X-ray phantom on the X-ray detector for a plurality of different poses of the radiation emitter and the X-ray detector, wherein a plurality of initial projections C(n, R0, t0) is ascertained.

Also part of the inventive calibration and control facility is a control unit for controlling an X-ray imaging system for capturing X-ray projection data from an examination object, wherein during capture of the X-ray projection data for a plurality of different poses of the radiation emitter and the X-ray detector, optical image data which reproduce poses of the X-ray detector relative to the radiation emitter is ascertained.

The inventive calibration and control facility also has a correction unit for ascertaining corrected projections on the basis of the poses of the X-ray detector, ascertained on the basis of the optical image data, relative to the radiation emitter and on the basis of the initial calibration.

Also part of the inventive calibration and control facility is a reconstruction unit for carrying out a reconstruction of X-ray image data on the basis of the captured X-ray projection data and the corrected projections C(n, R1, t1).

The inventive calibration and control facility shares the advantages of the inventive method for calibrated X-ray imaging, with an X-ray imaging system with a radiation emitter with variable pose and an X-ray detector with a variable pose which can be actuated independently of the variable pose of the radiation emitter.

The inventive X-ray imaging system has a radiation emitter which can be variably controlled in respect of its pose, an X-ray detector which can be actuated variably in respect of its pose independently of the variable pose of the radiation emitter and an inventive calibration and control facility. The X-ray imaging system shares the advantages of the inventive calibration and control facility and the inventive method for calibrated X-ray imaging, with an X-ray imaging system with a radiation emitter with variable pose and an X-ray detector with a variable pose which can be actuated independently of the variable pose of the radiation emitter.

The majority of the above-mentioned components of the inventive calibration and control facility can be implemented wholly or partially in the form of software modules in a processor of a corresponding computing system, for example by a control facility of an X-ray imaging system or a computer which is used for controlling such a system. An implementation largely in terms of software has the advantage that even previously used computing systems can be easily retrofitted by way of a software update in order to work inventively.

In this respect the object is also achieved by a corresponding computer program product with a computer program which can be loaded directly into a computing system, with program segments in order to execute the steps of the inventive method for calibrated X-ray imaging, with an X-ray imaging system with a radiation emitter with variable pose and an X-ray detector with a variable pose which can be actuated independently of the variable pose of the radiation emitter when the program is executed in the computing system. Apart from the computer program, such a computer program product can possibly comprise additional integral parts, such as documentation and/or additional components, also hardware components, such as hardware keys (dongles, etc.) in order to use the software.

A computer-readable medium, for example a memory stick, a hard disk or another transportable or permanently installed data carrier, on which the program segments of the computer program, which can be read-in and executed by a computing system, are stored, can serve for transportation to the computing system or the control facility and/or for storage on or in the computing system or the control facility. The computing system can have for this purpose, for example, one or more collaborating microprocessor(s) or the like.

The dependent claims as well as the description below respectively contain particularly advantageous embodiments and developments of the invention. In particular, the claims of one category of claims can also be developed analogously to the dependent claims of a different category of claims. In addition, within the context of the invention, the various features of different exemplary embodiments and claims can also be combined to form new exemplary embodiments.

In one embodiment of the inventive method for calibrated X-ray imaging, with an X-ray imaging system with a radiation emitter with variable pose and an X-ray detector with a variable pose which can be actuated independently of the variable pose of the radiation emitter in the step of carrying out an initial calibration, initial optical image data is captured by the radiation emitter and/or the X-ray detector. Initial optical image data should be taken to mean image data which is not generated with X-rays, but with an additional image recording unit which can be used in parallel with an X-ray recording.

Furthermore, initial poses of the X-ray detector relative to the radiation emitter are ascertained on the basis of the initial optical image data. Since the optical image data comprises items of information about the position and orientation of the radiation emitter and/or the X-ray detector, it can be used for ascertaining a relative pose between said components. That only relative poses are captured here is to do with the fact that the optical image data is captured from the perspective of the radiation emitter or the X-ray detector. Preferably, an image recording unit arranged on the radiation emitter captures an image from the X-ray detector or a marker arranged on the X-ray detector. The image is firstly captured in the coordinate system of the image recording unit and is then converted by a relative projection from a coordinate system of the image recording unit via a coordinate system of the radiation emitter to the coordinate system of the X-ray detector because the image recording unit is situated at a different position to the X-ray focal point. The initial relative poses ascertained in this way are advantageously subsequently used as reference values for ascertaining the corrected projections.

In a preferred variant of the inventive method for calibrated X-ray imaging, with an X-ray imaging system with a radiation emitter with variable pose and a X-ray detector with a variable pose which can be actuated independently of the variable pose of the radiation emitter, the initial optical image data is captured for at least two poses of the radiation emitter, rotated about a predetermined angle relative to each other, and of the X-ray detector. That is to say, the orientation of the radiation emitter and the X-ray detector are also different in the different recordings. A parameter curve as a trajectory of the radiation emitter and of the X-ray detector can be adjusted to the relative poses ascertained from these recordings and can subsequently be compared with such a trajectory, which is ascertained during the actual X-ray imaging, by way of a new recording of optical image data. Advantageously, the phase space of the possible poses is at least partially covered, so deviations and changes from these poses are subsequently robustly ascertained during the X-ray imaging.

In an alternative embodiment of the inventive method for calibrated X-ray imaging, with an X-ray imaging system with a radiation emitter with variable pose and a X-ray detector with a variable pose which can be actuated independently of the variable pose of the radiation emitter, the predetermined angle is 90°. Advantageously, the phase space of the possible poses is widely covered so deviations and changes from these poses can be ascertained more easily and reliably as well as more robustly.

In a preferred embodiment of the inventive method for calibrated X-ray imaging, with an X-ray imaging system with a radiation emitter with variable pose and an X-ray detector with a variable pose which can be actuated independently of the variable pose of the radiation emitter, the initial optical image data is captured by an image recording of a marker arranged on the X-ray detector by way of an image recording unit arranged on the radiation emitter. If the intrinsic projection parameters, i.e. in particular the detector point of impact and the focal width, are known, on the basis thereof and on the basis of the mapping of the marker, a pose of the radiation emitter relative to the X-ray can thus be ascertained.

Alternatively, the initial optical image data is captured for this by an image recording of a marker arranged on the radiation emitter by way of an image recording unit arranged on the X-ray detector. In this variant, the relative pose of the radiation emitter and the X-ray detector was captured in the reverse direction.

During the initial calibration the absolute pose of the X-ray detector preferably comprises its position and two vectors which span the plane of the detector surface of the X-ray detector. Advantageously, it is not just the position of the X-ray detector which is calibrated but also its orientation since the orientation of the detector surface can also influence the X-ray projection data generated during X-ray imaging.

Preferably, the transformation has a current rotation and/or a current translation of the X-ray detector. The deviation of the relative pose of the X-ray detector and the radiation emitter, which occurs during the actual X-ray imaging, from the initial relative pose can comprise a rotation as well as a translation. Advantageously, both deviations are captured and can also be incorporated in the correction of the captured X-ray projection data. The precision of the reconstruction of image data on the basis of the thus corrected X-ray projection data is consequently increased.

The image recording unit used for the recording of the optical image data preferably comprises a camera. A camera can generate image data with high resolution, which can be used for a precise adjustment of the X-ray projection data used for an image reconstruction.

Preferably, the relative poses of the radiation emitter and the X-ray detector are ascertained on the basis of intrinsic projection parameters of the image recording unit and the X-ray detector. As already mentioned, this data may be used for an exact ascertainment of a pose of an object relative to an image recording unit.

The inventive X-ray imaging system is preferably configured to carry out one of the following types of X-ray image recordings:
a dynamic scanning method,
   in particular
a CBCT method,
a truncated CBCT method,
a slot-scan method,
a True2Scale method,
a tomosynthesis method.

A dynamic scanning method entails changing poses, which are to be synchronized, of the radiation emitter and the X-ray detector. Therefore, the described inventive method may advantageously be applied to this type of method. The following specific imaging methods are particular types of dynamic scanning method.

A CBCT method serves to generate 3D image data by way of a rotating combination of a movable X-ray tube assembly and an X-ray detector which can move relative thereto. Unlike with a CT system, the X-ray beam is not fan-shaped but cone-shaped.

Truncated CBCT methods are described in the Article by Luckner C, Herbst M, Weber T, Beister M, Ritschl L, Kappler S, “High-speed slot-scanning radiography using small-angle tomosynthesis: Investigation of spatial resolution”, Medical Physics 46 (12), Dezember 2019, pages 5454-5466 (see also https://aapm.onlinelibrary.wiley.com/doi/10.1002/mp.13828).

Slot-scan methods are described in DE 10 2016 221 205 B4. Slot-scan methods are based on small-angle tomosynthesis.

In a tomosynthesis method, image data, for example for mammography or imaging the lungs, is obtained from the chest from different directions and on the basis of this image data, items of depth information are obtained for representing a chest image.

In one variant of the inventive calibration and control facility, the calibration and control facility, preferably the calibration unit of the calibration and control facility, has an initial unit for actuating an image recording unit for recording initial optical image data which maps a radiation emitter and/or an X-ray detector, and for receiving the initial optical image data.

In this variant, the inventive calibration and control facility also comprises a relative pose-ascertaining unit for ascertaining initial poses of the X-ray detector relative to the radiation emitter on the basis of the initial optical image data.

Part of the correction unit of the inventive calibration and control facility, or provided separately thereto, is preferably a transformation-ascertaining unit for ascertaining a transformation on the basis of the initial relative poses and the new relative poses, ascertained during the actual X-ray imaging, which indicates a deviation of the poses of the radiation emitter and the X-ray detector from the absolute calibrated poses of the initial calibration. As already mentioned, the ascertained calibrations can be used for an exact image reconstruction.

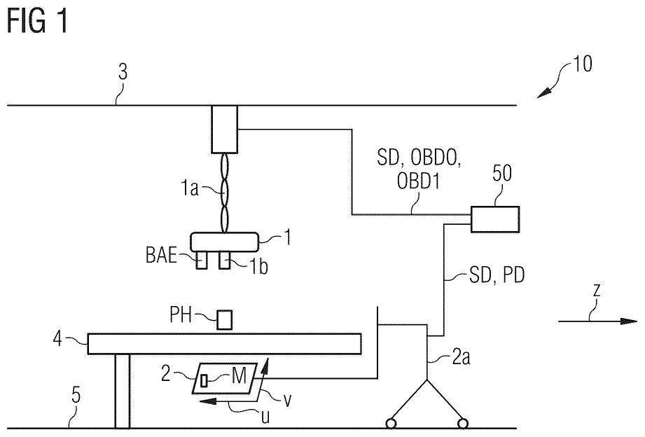

FIG. 1 shows a schematic representation of an X-ray imaging system 10 according to an exemplary embodiment of the invention. The X-ray imaging system 10 comprises a flexibly posable X-ray tube assembly, called a radiation emitter 1 for short, which can be seen in the center of the image, and a flexibly posable X-ray detector 2 represented in the lower region of the image. Shown by an arrow in the direction of the axis of rotation of the flexibly posable X-ray detector 2 is the z-direction of a world coordinate system, which in the simplest case represents a cylindrical coordinate system with the z-axis as the axis of rotation or axis of symmetry. The radiation emitter 1 is fastened with the aid of a flexible support arm 1a to a ceiling 3. Arranged on the radiation emitter 1, in addition to a beam opening 1b for emitting the X-ray radiation, is also a camera BAE, utilized as an optical image recording unit, which is used for generating optical image data OBD0, OBD1 from the X-ray detector 2. The radiation emitter 1 can be moved into any desired pose P1(n) by automatic movement of the flexible support arm 1a. Furthermore, a patient couch 4 can be seen in FIG. 1, and this is erected on a floor 5. The X-ray detector 2 is arranged on a rotatable and movable support system 2a with which the X-ray detector 2 can be moved into a desired pose P2(n). A marker M is attached to the X-ray detector 2 and this can be visually captured by the camera BAE. Vectors u, v are also represented in FIG. 1 and these span the detector surface of the X-ray detector 2. Arranged on the patient couch 4 is an X-ray phantom PH with which the poses P1(n) of the radiation emitter 1 and the poses P2(n) of the X-ray detector for N different projections can be initially calibrated KAL0. The thus generated absolute calibrated poses PABS1(n), PABS2(n), which are generated in the world coordinate system of the X-ray phantom PH, only have to be generated once and can be used again later for an image reconstruction.

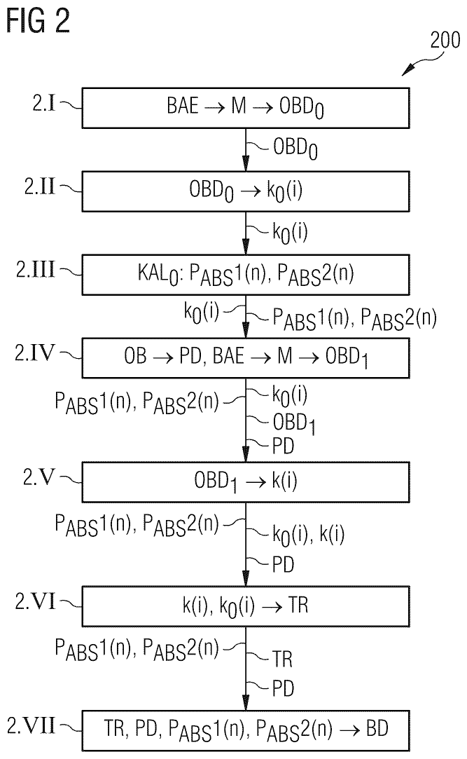

In order to compensate for deviations during imaging when approaching the poses, firstly initial relative poses k0(i) between the radiation emitter 1 and the X-ray detector 2 are additionally ascertained by the camera BAE from the marker M by way of the generation of initial optical image data OBD0 during the initial calibration KAL0. If the X-ray imaging system 10 is subsequently used for capturing X-ray projection data PD from an examination region UB of a patient (not shown), new optical image data OBD1 is thus captured from the marker M during recording of the X-ray projection data PD, on the basis of which new data, new poses k(i) of the X-ray detector 2 relative to the radiation emitter 1 are ascertained. On the basis of the initial relative poses k0(i) and the new relative poses k(i), a transformation TR (see FIG. 2) can now be ascertained which indicates a deviation of the poses P1, P2 of the radiation emitter 1 and the X-ray detector 2 from the absolute calibrated poses PABS1(n), PABS2(n). Finally, the transformation TR can be used for a type of “virtual” calibration in order to generate current absolute poses P1(n), P2(n) of the radiation emitter 1 and the X-ray detector 2, or pose data associated therewith, on the basis of which a reconstruction of X-ray image data BD (see FIG. 2) is carried out.

FIG. 1 also shows a calibration and control facility (also referred to as a calibration and control device) 50 according to an exemplary embodiment of the invention, with which a calibration of the entire system as well as an X-ray imaging can be carried out via the emitting of control data SD and the receiving of optical image data OBD0, OBD1 and X-ray projection data PD.

FIG. 2 is a flowchart 200 which illustrates a method for calibrated X-ray imaging, with an X-ray imaging system 10 with a radiation emitter 1 with variable pose P1 and an X-ray detector 2 with a variable pose 2 which can be actuated independently of the variable pose P1 of the radiation emitter 1, according to a first exemplary embodiment of the invention.

In step 2.I, firstly initial optical image data OBD0 is recorded by a camera BAE arranged on the radiation emitter 1 from a marker M attached to the X-ray detector 2 for a plurality of i=2 of different initial poses k0(i) of the X-ray detector 2 relative to the radiation emitter 1. The actuated poses of the radiation emitter and the X-ray detector are selected such that the orientation of the radiation emitter 1 differs by an angle of 90° between the different poses. Figuratively speaking, different orientations of the radiation emitter 1 and the X-ray detector 2 are therefore set, which differ by 900 respectively, so the phase space of the possible poses is uniformly covered to some extent.

In step 2.II, initial poses k0(i) of the X-ray detector 2 relative to the radiation emitter 1 are ascertained on the basis of the initial optical image data OBD0.

In step 2.III, an initial calibration KAL0 is carried out by ascertaining absolute calibrated poses PABS1(n), PABS2(n) of the radiation emitter 1 and the X-ray detector 2 by way of an X-ray mapping of an X-ray phantom PH on the X-ray detector 2 for a plurality of different poses P1(n), P2(n) of the radiation emitter 1 and the X-ray detector 2.

In step 2.IV, the X-ray imaging system 10 is employed for capturing X-ray projection data PD from an examination object OB. New optical image data OBD1 respectively is captured by the camera BAE from the marker M during capture of the X-ray projection data PD for a plurality of the absolute calibrated poses PABS1(n), PABS2(n) of the radiation emitter 1 and the X-ray detector 2.

New poses k(i) of the X-ray detector 2 relative to the radiation emitter 1 are ascertained in step 2.V on the basis of the new optical image data OBD1 captured in step 2.IV.

In step 2.VI, a transformation TR is ascertained on the basis of the initial relative poses k0(i) and the new relative poses k(i). The transformation TR indicates a deviation of the poses P1, P2 of the radiation emitter 1 and the X-ray detector 2 during capture of the X-ray projection data PD from the absolute calibrated poses PABS1(n), PABS2(n) of the initial calibration KAL0.

In step 2.VII, X-ray image data BD is reconstructed on the basis of the captured X-ray projection data PD, the absolute calibrated poses PABS1(n), (PABS2(n) of the radiation emitter 1 and the X-ray detector 2 and the transformation TR. The absolute calibrated poses PABS1(n), (PABS2(n) are corrected with the aid of the transformation TR and the corrected poses are used for the reconstruction of the image data BD.

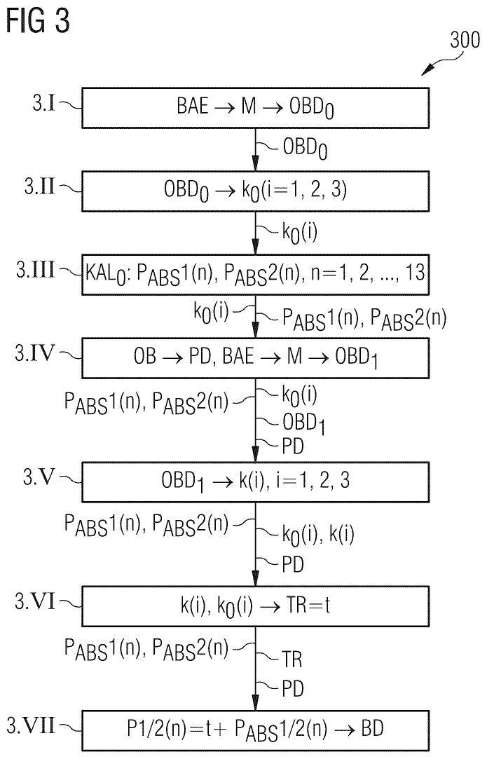

FIG. 3 shows a flowchart 300 which illustrates a method for calibrated X-ray imaging, with an X-ray imaging system 10 with a radiation emitter 1 with variable pose P1 and an X-ray detector 2 with a variable pose 2 which can be actuated independently of the variable pose P1 of the radiation emitter 1, according to a second exemplary embodiment of the invention. The flowchart 300 illustrated in FIG. 3 and the accompanying text are intended to clarify the procedure in the inventive method in detail using a simple numerical example.

In step 3.I, similar to in the example illustrated in FIG. 2, firstly initial optical image data OBD0 is recorded by a camera BAE from a marker M attached to the X-ray detector 2 for a plurality of three different initial poses k0(i) of the X-ray detector 2 relative to the radiation emitter 1. These poses are selected such that the orientation of the radiation emitter 1 differs by an angle of 90° between the different poses.

In step 3.II, initial poses k0(i) of the X-ray detector 2 relative to the radiation emitter 1 are ascertained on the basis of the initial optical image data OBD0.

In the particularly simple case explained here, the radiation emitter 1 and the X-ray detector 2 are shifted relative to each other in the z-direction (see FIG. 1) by one centimeter. For simplification, only relative positions are considered in this example. The relative positions would then be in this case simply:

$$k 0 ( 1 ) = ( Δφ = 90 ° - 270 ° , R 1 - R 2 [ cm ] , Δ z = 1 [ cm ] ) ,$$

$$k 0 ( 2 ) = ( Δφ = 180 ° - 0 ° , R 1 - R 2 [ cm ] , Δ z = 1 [ cm ] ) ,$$

$$k 0 ( 3 ) = ( Δφ = 270 ° - 90 ° , R 1 - R 2 [ cm ] , Δ z = 1 [ cm ] ) .$$

In this connection, R1 denotes the radial spacing of the radiation emitter 1 from the z-axis, R2 denotes the radial spacing of the X-ray detector 2 from the z-axis, the angular differences Δφ denote the differences between the respective angular positions φ1, φ2 of the radiation emitter 1 and the X-ray detector 2 when capturing the initial optical image data OBD0 and Δz=1 [cm] denotes a shift between the radiation emitter 1 and the X-ray detector 2 in the z-direction, which shift occurs in the space in each of the three different orientations of the radiation emitter 1 and the X-ray detector 2.

In step 3.III, an initial calibration KAL0 is carried out by ascertaining absolute calibrated poses PABS1(n), PABS2(n) of the radiation emitter 1 and the X-ray detector 2 by way of X-ray mapping of an X-ray phantom PH on the X-ray detector 2 for a plurality of different poses P1(n), P2(n) of the radiation emitter 1 and the X-ray detector 2. The number of calibrated projections is in this case N=13.

The absolute poses can have, for example, the following coordinates:

$$PABS 1 ( n = 1 ) = ( 30 ° , R 1 [ cm ] , z = 0 [ cm ] ) ,$$

$$PABS 1 ( n = 2 ) = ( 40 ° , R 1 [ cm ] , z = 0 [ cm ] ) ,$$

$$...$$

$$PABS 1 ( n = 13 ) = ( 150 ° , R 1 [ cm ] , z = 0 [ cm ] ) ;$$

$$PABS 2 ( n = 1 ) = ( 210 ° , R 2 [ cm ] , z = 1 [ cm ] ) ,$$

$$PABS 2 ( n = 2 ) = ( 220 ° , R 2 [ cm ] , z = 1 [ cm ] ) ,$$

$$...$$

$$PABS 2 ( n = 13 ) = ( 350 ° , R 2 [ cm ] , z = 1 [ cm ] ) .$$

The actual calibration is concluded herewith.

When the X-ray imaging system 10 is used in step 3.IV for capturing X-ray projection data PD from an examination object OB, new optical image data OBD1 respectively is captured by the camera BAE from the marker M during capture of the X-ray projection data PD for a plurality of the absolute calibrated poses PABS1(n), PABS2(n) of the radiation emitter 1 and the X-ray detector 2.

In step 3.V, new poses k(i) of the X-ray detector 2 relative to the radiation emitter 1 are then ascertained on the basis of this new optical image data OBD1:

$$k ( 1 ) = ( Δφ = 30 ° - 210 ° , R 1 - R 2 [ cm ] , Δ z = 2 [ cm ] ) ,$$

$$k ( 2 ) = ( Δφ = 90 ° - 270 ° , R 1 - R 2 [ cm ] , Δ z = 2 [ cm ] ) ,$$

$$k ( 3 ) = ( Δφ = 150 ° - 350 ° , R 1 - R 2 [ cm ] , Δ z = 2 [ cm ] ) .$$

While the relative angles φ1-φ2 of the radiation emitter 1 and the X-ray detector 2 and the relative axial spacings R1-R2 from the z-axis have not changed, compared to the initial calibration KAL0, the X-ray detector 2 has shifted relative to the radiation emitter 1 by a further centimeter in the z-direction.

A transformation R is now calculated in step 3.VI on the basis of the initial relative poses k0(i) and the new relative poses k(i), which transformation in this simple case comprises just a translation t:

$$TR = t = ( 0 , 0 , Δ z = 1 [ cm ] ) .$$

The true coordinates P1, P2 of the radiation emitter 1 and the X-ray detector 2 are therefore:

$$P 1 / 2 ( n ) = t + PABS 1 / 2 ( n ) .$$

In detail, the following results for the projections:

$$P 1 ( n = 1 ) = ( 30 ° , R 1 [ cm ] , z = 0 [ cm ] ) ,$$

$$P 1 ( n = 2 ) = ( 40 ° , R 1 [ cm ] , z = 0 [ cm ] ) ,$$

$$...$$

$$P 1 ( n = 13 ) = ( 150 ° , R 1 [ cm ] , z = 0 [ cm ] ) ;$$

$$P 2 ( n = 1 ) = ( 210 ° , R 2 [ cm ] , z = 2 [ cm ] ) ,$$

$$P 2 ( n = 2 ) = ( 220 ° , R 2 [ cm ] , z = 2 [ cm ] ) ,$$

$$...$$

$$P 2 ( n = 13 ) = ( 350 ° , R 2 [ cm ] , z = 2 [ cm ] ) .$$

In step 3.VII, a reconstruction now takes place on the basis of the thus corrected projection data PD, with the positions P1/2(n) of the radiation emitter 1 or the X-ray detector 2 as P1/2(n)=t+PABS1/2(n) forming the basis of the image reconstruction.

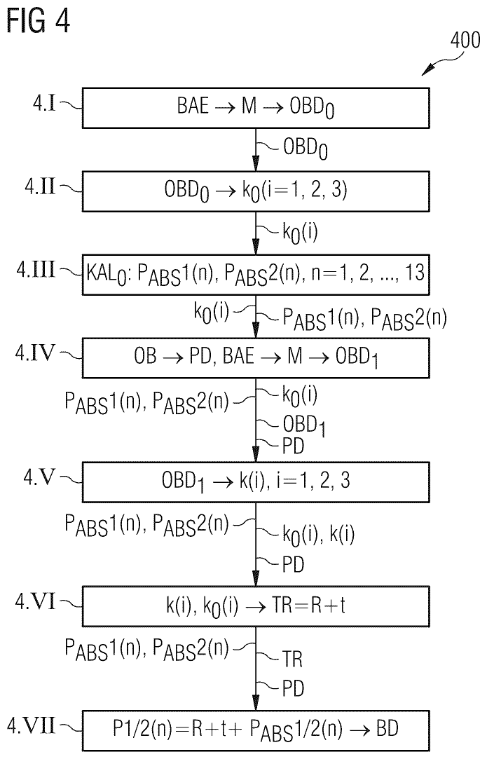

FIG. 4 shows a flowchart 400 which illustrates a method for calibrated X-ray imaging, with an X-ray imaging system 10 with a radiation emitter 1 with variable pose and an X-ray detector 2 with a variable pose which can be actuated independently of the variable pose of the radiation emitter 1, according to a third exemplary embodiment of the invention. In the third exemplary embodiment illustrated in FIG. 4, there is not only a misaligning shift Δz between the radiation emitter 1 and the X-ray detector 2 in the direction of the z-axis, but also a shift Δφ. In addition to a translation t, the transformation TR calculated in step 4.VI consequently also comprises a rotation R.

In step 4.I, as in the prior examples, firstly initial optical image data OBD0 is again recorded by a camera BAE from a marker M attached to the X-ray detector 2 for a plurality of three different initial poses k0(i) of the X-ray detector 2 relative to the radiation emitter 1. These poses are selected such that the orientation of the radiation emitter 1 differs by an angle of 90° between the different poses.

In step 4.II, initial poses k0(i) of the X-ray detector 2 relative to the radiation emitter 1 are ascertained on the basis of the initial optical image data OBD0.

In the particular case explained here, the radiation emitter 1 and the X-ray detector 2 are shifted relative to each other by a centimeter in the z-direction and in the (p-direction are rotated by one degree relative to each other. For simplification, only relative positions are considered in this example. In this case the relative positions would then be:

$$k 0 ( 1 ) = ( Δ ( 91 ° , 270 ° ) = 181 ° , R 1 - R 2 [ cm ] , Δ z = 1 [ cm ] ) ,$$

$$k 0 ( 2 ) = ( Δ ( 181 ° , 0 ° ) = 181 ° , R 1 - R 2 [ cm ] , Δ z = 1 [ cm ] ) ,$$

$$k 0 ( 3 ) = ( Δ ( 271 ° , 90 ° ) = 181 ° , R 1 - R 2 [ cm ] , Δ z = 1 [ cm ] ) .$$

In this connection, R1 denotes the radial spacing of the radiation emitter 1 from the z-axis, R2 denotes the radial spacing of the X-ray detector 2 from the z-axis, the angles denote the respective angular positions φ1, φ2 of the radiation emitter 1 and the X-ray detector 2 during capture of the initial optical image data OBD0 and Δz=1 [cm] denotes a shift between the radiation emitter 1 and the X-ray detector 2 in the z-direction, which shift occurs in the space in each of the three different orientations of the radiation emitter 1 and the X-ray detector 2.

In step 4.III, an initial calibration KAL0 is carried out by ascertaining absolute calibrated poses PABS1(n), PABS2(n) of the radiation emitter 1 and the X-ray detector 2 by an X-ray mapping of a X-ray phantom PH on the X-ray detector 2 for a plurality of different poses P1(n), P2(n) or projections of the radiation emitter 1 and the X-ray detector 2. In this case the number of calibrated projections is N=13.

The absolute poses can have, for example, the following coordinates:

$$PABS 1 ( n = 1 ) = ( 31 ° , R 1 [ cm ] , z = 0 [ cm ] ) ,$$

$$PABS 1 ( n = 2 ) = ( 41 ° , R 1 [ cm ] , z = 0 [ cm ] ) ,$$

$$...$$

$$PABS 1 ( n = 13 ) = ( 151 ° , R 1 [ cm ] , z = 0 [ cm ] ) ;$$

$$PABS 2 ( n = 1 ) = ( 210 ° , R 2 [ cm ] , z = 1 [ cm ] ) ,$$

$$PABS 2 ( n = 2 ) = ( 220 ° , R 2 [ cm ] , z = 1 [ cm ] ) ,$$

$$...$$

$$PABS 2 ( n = 13 ) = ( 350 ° , R 2 [ cm ] , z = 1 [ cm ] ) .$$

The actual calibration is concluded herewith.

When the X-ray imaging system 10 is used in step 4.IV for capturing X-ray projection data PD from an examination object OB, new optical image data OBD1 respectively is captured by the camera BAE from the marker M during capture of the X-ray projection data PD for a plurality of the absolute calibrated poses PABS1(n), PABS2(n) of the radiation emitter 1 and the X-ray detector 2.

In step 4.V, new poses k(i) of the X-ray detector 2 relative to the radiation emitter 1 are then ascertained on the basis of this new optical image data OBD1:

$$k ( 1 ) = ( Δ ( 32 ° , 210 ° ) = 182 ° , R 1 - R 2 [ cm ] , Δ z = 2 [ cm ] ) ,$$

$$k ( 2 ) = ( Δ ( 92 ° , 270 ° ) = 182 ° , R 1 - R 2 [ cm ] , Δ z = 2 [ cm ] ) ,$$

$$k ( 3 ) = ( Δ ( 152 ° , 350 ° ) = 182 ° , R 1 - R 2 [ cm ] , Δ z = 2 [ cm ] ) .$$

Here, in contrast to the exemplary embodiment illustrated in FIG. 3, the relative angles φ1-φ2 of the radiation emitter 1 and the X-ray detector 2 have likewise changed after the initial calibration KAL0, while, compared to the initial calibration KAL0, the relative axial spacings R1-R2 from the z-axis have not changed, and the X-ray detector 2 has shifted relative to the radiation emitter 1 by a further centimeter in the z-direction.

On the basis of the initial relative poses k0(i) and the new relative poses k(i), a transformation R is again now calculated in step 4. VI, which in this simple case comprises just a translation t:

$$TR = R + t = ( Δφ = 1 ° , 0 , Δ z = 1 [ cm ] ) .$$

The true coordinates P1, P2 of the radiation emitter 1 and the X-ray detector 2 are therefore:

$$P 1 / 2 ( n ) = R + t + PABS 1 / 2 ( n ) .$$

In detail the following results for the projections:

$$P 1 ( n = 1 ) = ( 32 ° , R 1 [ cm ] , z = 0 [ cm ] ) ,$$

$$P 1 ( n = 2 ) = ( 42 ° , R 1 [ cm ] , z = 0 [ cm ] ) ,$$

$$...$$

$$P 1 ( n = 13 ) = ( 152 ° , R 1 [ cm ] , z = 0 [ cm ] ) ;$$

$$P 2 ( n = 1 ) = ( 210 ° , R 2 [ cm ] , z = 2 [ cm ] ) ,$$

$$P 2 ( n = 2 ) = ( 220 ° , R 2 [ cm ] , z = 2 [ cm ] ) ,$$

$$...$$

$$P 2 ( n = 13 ) = ( 350 ° , R 2 [ cm ] , z = 2 [ cm ] ) .$$

In step 4.VII, a reconstruction now takes place on the basis of the projection data PD corrected by the pose correction, with the positions of the radiation emitter 1 or the X-ray detector 2, where P1/2(n)=R+t+PABS1/2(n), being used as the basis for the image reconstruction.

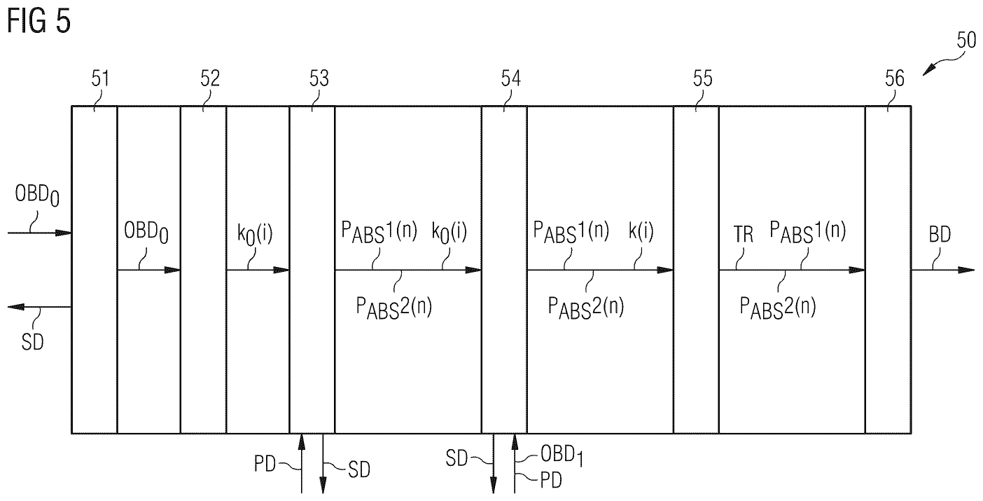

FIG. 5 shows a schematic representation of a calibration and control facility 50 according to an exemplary embodiment of the invention.

The calibration and control facility 50 comprises an initial unit 51 for actuating a camera BAE of a radiation emitter 1 of an X-ray imaging system 10, with control data SD for generating initial optical image data OBD0 which maps an X-ray detector 2 from a radiation emitter 1, and for receiving this initial optical image data OBD0. Also part of the calibration and control facility 50 is a relative pose-ascertaining unit 52 for ascertaining initial poses k0(i) of the X-ray detector (2) relative to the radiation emitter (1) on the basis of the initial optical image data OBD0.

The calibration and control facility 50 also has a calibration unit 53 for carrying out an initial calibration KAL0 by ascertaining absolute calibrated poses PABS1(n), PABS2(n) of the radiation emitter 1 and the X-ray detector 2 by way of X-ray mapping of an X-ray phantom PH on the X-ray detector 2 for a plurality of different poses P1(n), P2(n) of the radiation emitter 1 and the X-ray detector 2. For this, control data SD is transmitted to the radiation emitter 1 and the X-ray detector 2 and X-ray projection data PD is received by the X-ray detector 2.

In addition, the calibration and control facility 50 comprises a control unit 54 (also referred to as a controller). The control unit serves to control an X-ray imaging system 10 for X-ray imaging an examination object OB. New optical image data OBD1 respectively is captured during capture of the X-ray projection data PD for a plurality of the absolute calibrated poses PABS1(n), PABS2(n) of the radiation emitter 1 and the X-ray detector 2 and new poses k(i) of the X-ray detector 2 relative to the radiation emitter 1 are ascertained on the basis of this new data.

Furthermore, the calibration and control facility 50 has a transformation-ascertaining unit 55 for ascertaining a transformation TR on the basis of the initial relative poses k0(i) and the new relative poses k(i). The transformation TR indicates a deviation of the poses P1, P2 of the radiation emitter 1 and the X-ray detector 2 from the absolute calibrated poses PABS1(n), PABS2(n) of the initial calibration KAL0.

Also part of the calibration and control facility 50 is a reconstruction unit 56 for carrying out a reconstruction of X-ray image data BD on the basis of the captured X-ray projection data PD, the absolute calibrated poses PABS1(n), PABS2(n) of the radiation emitter 1 and the X-ray detector 2 and the transformation TR.

In conclusion, it will be pointed out once again that the above-described methods and apparatuses are merely preferred exemplary embodiments of the invention and that the invention can be modified by a person skilled in the art without departing from the scope of the invention insofar as it is specified by the claims. For the sake of completeness it is also pointed out that use of the indefinite article “a” or “an” does not preclude the relevant features from also being present multiple times. Similarly, the term “unit” does not preclude this from being composed of a plurality of components which can possibly also be spatially distributed. Independent of the grammatical term usage, individuals with male, female or other gender identities are included within the term.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

1. A method for calibrated X-ray imaging, with an X-ray imaging system with a radiation emitter with variable pose and an X-ray detector with a variable pose which can be actuated independently of the variable pose of the radiation emitter, the method comprising:
performing an initial calibration using an X-ray mapping of an X-ray phantom on the X-ray detector for a plurality of different poses of the radiation emitter and the X-ray detector to ascertain a plurality of initial projections;
using the X-ray imaging system to capture X-ray projection data from an examination object for a plurality of different poses of the radiation emitter and the X-ray detector and ascertain optical image data, the optical image data reproducing the plurality of different poses of the X-ray detector relative to the radiation emitter, determining new relative poses;
ascertaining corrected projections of the X-ray detector relative to the radiation emitter based on the initial calibration and the new poses from the optical image data; and
reconstructing X-ray image data based on the captured X-ray projection data and the corrected projections.

2. The method of claim 1, wherein the performing the initial calibration comprises:
capturing initial optical image data from at least one of the radiation emitter or the X-ray detector,
ascertaining initial poses of the X-ray detector relative to the radiation emitter based on the initial optical image data, and
ascertaining absolute calibrated poses of the radiation emitter and the X-ray detector using the X-ray mapping of the X-ray phantom on the X-ray detector for the plurality of different poses of the radiation emitter and the X-ray detector, the plurality of initial projections being based on the absolute calibrated poses.

3. The method of claim 2, wherein the initial optical image data is captured for at least two poses, rotated relative to each other by a predetermined angle, of the radiation emitter and the X-ray detector.

4. The method of claim 3, wherein the predetermined angle is 90°.

5. The method of claim 2, wherein the initial optical image data and the optical image data are captured using an image recording of a marker arranged on the X-ray detector by an image recording unit arranged on the radiation emitter.

6. The method of claim 2, wherein the initial optical image data and the optical image data are captured using an image recording of a marker arranged on the radiation emitter by an image recording unit arranged on the X-ray detector.

7. The method of claim 3, wherein the ascertaining the corrected projections comprises ascertaining a transformation based on the initial relative poses and the new relative poses and applying the transformation to the initial projections.

8. The method of claim 1, wherein the initial projections and the corrected projections comprise positions of the radiation emitter and the X-ray detector and two vectors which span a plane of a detector surface of the X-ray detector.

9. The method of claim 3, wherein the initial relative poses are ascertained based on intrinsic projection parameters of an image recording unit and the X-ray detector.

10. A calibration and control device, comprising:
a calibration unit configured to perform an initial calibration using an X-ray mapping of a X-ray phantom on a X-ray detector for a plurality of different poses of a radiation emitter and the X-ray detector to ascertain a plurality of initial projections;
a controller configure to control an X-ray imaging system to capture X-ray projection data from an examination object for a plurality of different poses of the radiation emitter and the X-ray detector and ascertain optical image data, the optical image data reproducing the plurality of different poses of the X-ray detector relative to the radiation emitter, determining new relative poses;
a correction unit configured to ascertain corrected projections of the X-ray detector relative to the radiation emitter based on the initial calibration and the new poses from the optical image data; and
a reconstruction unit configured to reconstruct X-ray image data based on the captured X-ray projection data and the corrected projections.

11. An X-ray imaging system, comprising:
a radiation emitter having a variably controllable pose;
an X-ray detector having a variably actuated pose independent of the pose of the radiation emitter; and
the calibration and control device of claim 10.

12. The X-ray imaging system of claim 11, configured to perform out one of the following types of X-ray image recording:
a dynamic scanning method,
a Cone Beam Computed Tomography (CBCT) method,
a truncated CBCT method,
a slot-scan method,
a True2Scale method, and
a tomosynthesis method.

13. A non-transitory computer program product comprising commands, when executed by a computer, cause the computer to perform the method of claim 1.

14. A non-transitory computer-readable storage medium comprising commands, when executed by a computer, cause the computer to perform the method of claim 1.

15. The method of claim 3, wherein the initial optical image data and the optical image data are captured using an image recording of a marker arranged on the X-ray detector by an image recording unit arranged on the radiation emitter.

16. The method of claim 3, wherein the initial optical image data and the optical image data are captured using an image recording of a marker arranged on the radiation emitter by an image recording unit arranged on the X-ray detector.

17. The method of claim 3, wherein the ascertaining the corrected projections comprises ascertaining a transformation based on the initial relative poses and the new relative poses and applying the transformation to the initial projections.

18. The method of claim 17, wherein the initial projections and the corrected projections comprise positions of the radiation emitter and the X-ray detector and two vectors which span a plane of a detector surface of the X-ray detector.

19. The method of claim 4, wherein the initial relative poses are ascertained based on intrinsic projection parameters of an image recording unit and the X-ray detector.
